(19) United States
(12) Patent Application Publication
(10) Pub. No.: US 2020/0015568 A1
(43) Pub. Date: Jan. 16, 2020

(54) MAKEUP APPLICATOR

(71) Applicant: Li-Fen KANG, Zihlong Village (TW)

(72) Inventor: Li-Fen KANG, Zihlong Village (TW)

(21) Appl. No.: 16/429,372

(22) Filed: Jun. 3, 2019

(30) Foreign Application Priority Data
Jul. 13, 2018 (TW) 107209478

(51) Int. Cl. A45D 34/04; A45D 34/06; A45D 40/26

(52) U.S. Cl. CPC A45D 34/04; A61Q 1/06; A45D 40/265; A45D 34/06

(57) ABSTRACT

A makeup applicator includes a tube unit, a refill unit, and a control unit. The tube unit is hollow and extends along a central axis. The refill unit is detachably mounted in the tube unit, and includes a cosmetic-receiving tube defining a passage that extends along the central axis therein and a cosmetic stick movable in the passage. The control unit includes a pushing rod movably inserted into the passage and co-movably connected to the cosmetic stick, and at least one roller rotatably mounted to the tube unit and rotatable to drive the pushing rod to move along the central axis together with the cosmetic stick.

### CROSS-REFERENCE TO RELATED APPLICATION

This application claims priority to Taiwanese Patent Application No. 107209478 filed on Jul. 13, 2018.

### FIELD

The disclosure relates to a makeup applicator, more particularly to a makeup applicator receiving a cosmetic stick therein.

### BACKGROUND

Generally, a conventional makeup applicator includes a tube unit and a cosmetic stick disposed in the tube unit. Taiwanese Utility Model Patent Nos. 236103, M465064, and M508954 disclose various types of makeup applicators that can be operated to move the cosmetic stick to be exposed outwardly of the tube unit thereof by pressing or rotating tube unit. However, the cosmetic stick is usually made of a relatively soft material and may be damaged or fractured when applying makeup.

### SUMMARY

Therefore, an object of the disclosure is to provide a makeup applicator capable of alleviating at least the drawback of the prior art.

According to one aspect of the disclosure, a makeup applicator is provided to include a tube unit, a refill unit, and a control unit. The tube unit is hollow and extends along a central axis. The refill unit is detachably mounted in the tube unit, and includes a cosmetic-receiving tube and a cosmetic stick. The cosmetic-receiving tube defines a passage extending along the central axis therein. The cosmetic stick is movable in the passage. The control unit includes a pushing rod movably inserted into the passage and co-movably connected to the cosmetic stick, and at least one roller rotatably mounted to the tube unit and rotatable to drive the pushing rod to move along the central axis together with the cosmetic stick.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of a makeup applicator according to the embodiment of this disclosure;

FIG. 2 is a sectional view of the makeup applicator of the embodiment;

FIG. 3 is a fragmentary enlarged sectional view of the makeup applicator of the embodiment; and

FIG. 4 is a cross-sectional view of the makeup applicator, illustrating a control unit of the makeup applicator of the embodiment.

### DETAILED DESCRIPTION

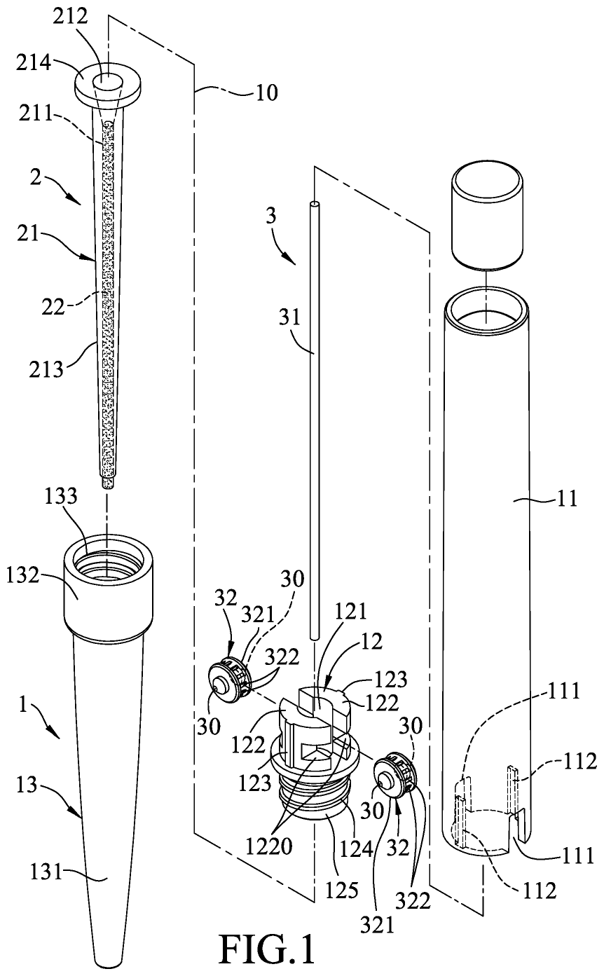

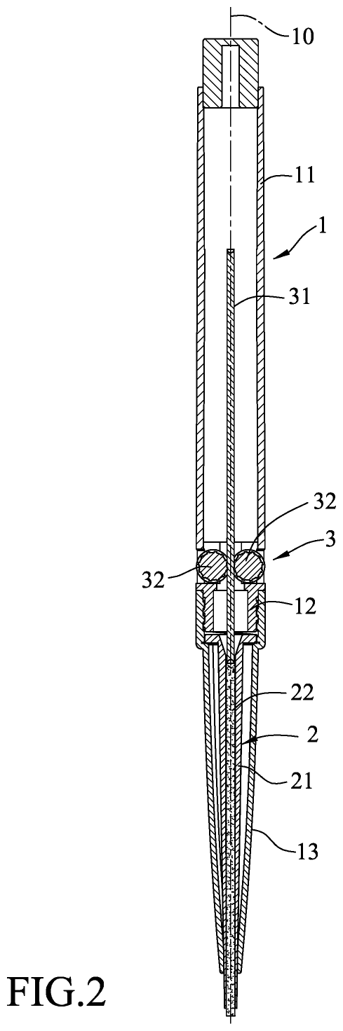

Referring to FIGS. 1-4, a makeup applicator according to one embodiment of the present disclosure is shown. The makeup applicator includes a tube unit 1, a refill unit 2, and a control unit 3. The tube unit 1 is hollow, extends along a central axis 10 and includes a tube body 11, a roller seat 12 connected to a lower end of the tube body 11, and a tip portion 13 extending downwardly from the tube body 11 along the central axis 10 and detachably connected to the roller seat 12. The tube body 11 is formed with two first engaging portion 112 extending in a direction parallel to the central axis 10.

The roller seat 12 defines a channel 121 extending along the central axis 10, includes two roller mounting portions 122 and a tip-connecting portion 125, and is formed with two second engaging portions 123. The roller mounting portions 122 extend into the tube body 11. The tip-connecting portion 125 extends downwardly from the tube body 11 into the tip portion 13 and is formed with an external thread 124. Each of the second engaging portions 123 extends in a direction parallel to the central axis 10 and engages a respective one of the first engaging portions 112 so as to prevent the roller seat 12 from rotating relative to the tube body 11. Note that as long as the first engaging portions 112 and the second engaging portions 123 have the same number, the number of the respective first and second engaging portions 112, 123 is not limited to two. In this embodiment, each of the first engaging portions 112 is an open-ended slot and each of the second engaging portions 123 is a rib, but the present disclosure is not limited to the example disclosed herein. For example, each first engaging portion 112 is a rib and each second engaging portion 123 is an open-ended slot in other embodiments of the present disclosure.

The tip portion 13 includes an upright outer sleeve 131 surrounding the central axis 10, a connection wall 132 connected to an upper end of the outer sleeve 131, and a shoulder wall 130 formed between the outer sleeve 131 and the connecting wall 132. The connecting wall 132 is formed with an internal thread 133 threadedly and detachably engaging the external thread 124 formed on the tip-connecting portion 125 of the roller seat 12.

The refill unit 2 is detachably mounted in the tip portion 13 of the tube unit 1, and includes a cosmetic-receiving tube 21 and a cosmetic stick 22. The cosmetic-receiving tube 21 defines a passage 211 extending along the central axis 10 therein and in spatial communication with the channel 121 defined by the roller seat 12. The cosmetic stick 22 is movable in the passage 211. The cosmetic-receiving tube 21 further defines a guiding portion 212 extending from the passage 211 upwardly toward the tube body 11 and having a gradually increasing cross section area toward the tube body 11, i.e., the guiding portion 212 is substantially funnel-shaped.

The cosmetic-receiving tube 21 includes an upright inner tube portion 213 and a flange portion 214. The outer sleeve 131 of the tip portion 13 is sleeved on the upright inner tube portion 213. The flange portion 214 extend radially and outwardly from an upper end of the inner tube portion 213, is disposed on and abuts against the shoulder wall 130 of the tip portion 13, and is disposed under the tip-connecting portion 125 of the roller seat 12. When the tip portion 13 is threadedly mounted to the roller seat 12, the refill unit 2 is thus positioned in the upright outer sleeve 131 of the tip portion 13.

The cosmetic stick 22 is, for example, an eyebrow stick, an eyeliner stick, a lip liner stick, a lipstick, a lip balm, a concealer stick, a foundation stick, etc. and the present disclosure is not limited to the disclosure herein. Each of the cosmetic stick 22 and the passage 211 is circular in cross section, and the cosmetic stick 22 has a maximum diameter smaller than that of the passage 211. Note that the refill unit 2 can be manufactured, packed and provided for sale independently.

The control unit 3 includes a pushing rod 31 and two rollers 32. The pushing rod 31 extends through the channel 121 defined by the roller seat 12, is movably inserted into the passage 211 and is co-movably connected to the cosmetic stick 22. The rollers 32 are respectively mounted to the roller mounting portions 122 of the roller seat 12, are disposed respectively and rotatably at diametrically opposite sides of the pushing rod 31, and are rotatable to drive the pushing rod 31 to move along the central axis 10 together with the cosmetic stick 22. Note that in this embodiment, the tube body 11 is further formed with two openings 111 in spatial communication with the passage 211 and the ambient surroundings. Each of the openings 111 corresponds in position to a respective one of the rollers 32 to allow a portion of the roller 32 to be exposed therein and allow the portion of the respective one of the rollers 32 to be operated by a user.

In this embodiment, once the pushing rod 31 is moved to contact the cosmetic stick 22, the cosmetic stick 22 is adhered to the pushing rod 31 so as to move together with the pushing rod 31 in the passage 211 when the rollers 32 are rotated.

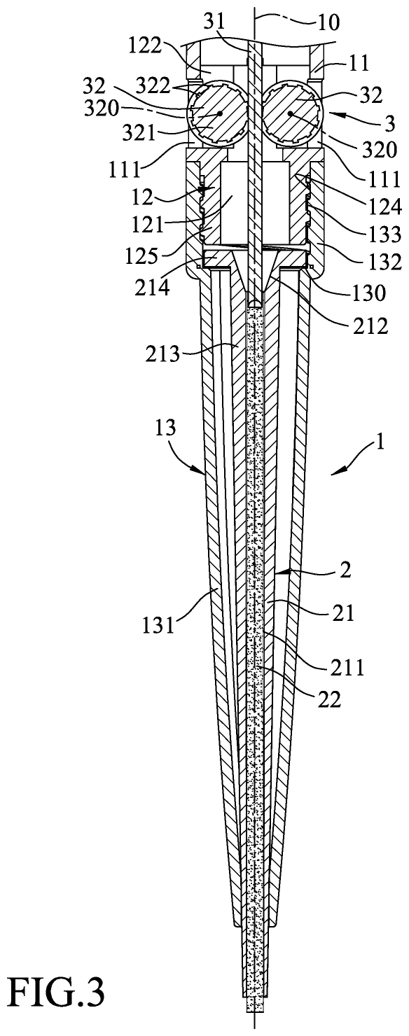

Specifically, each of the rollers 32 is rotatable about a horizontal axis 320 (see FIG. 3) transverse to the central axis 10. The horizontal axes 320 of the rollers 32 are parallel to each other. Each of the rollers 32 includes a wheel body 321 and a plurality of pawls 322.

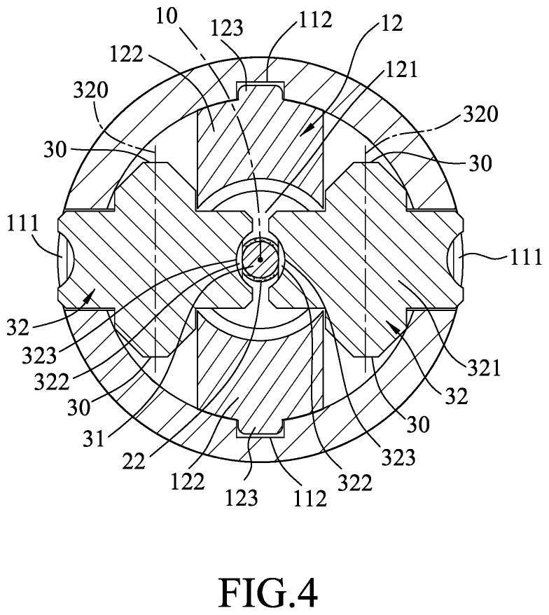

Since the rollers 32 have the same structure, only one of the rollers 32 will be described in this paragraph. The wheel body 321 is rotatable about a respective one of the horizontal axes 320 and has a wheel peripheral surface formed with an annular groove 323 (see FIG. 4). A portion of the wheel peripheral surface of one of the rollers 32 faces and cooperates with a portion of the wheel peripheral surface of the other one of the rollers 32 to surround the pushing rod 31. For each of the rollers 32, the pawls 322 extend radially and outwardly from the peripheral surface of the wheel body 321 and are angularly and equidistantly spaced apart from one another about the horizontal axis 320, and each of the pawls 322 is disposed in the annular groove 323 of a corresponding one of the wheel bodies 321 of the rollers 32. One of the pawls 322 of one of the rollers 32 faces and cooperates with a corresponding one of the pawls 322 of the other one of the rollers 32 to clamp the pushing rod 31 therebetween so as to move the pushing rod 31 in the passage 211 when the rollers 32 are rotated in opposite directions.

In this embodiment, each of the rollers 32 includes two rotating shafts 30 extending respectively from two opposite ends of the wheel body 321 of the roller 32 away from each other along the horizontal axis 320. Each of the roller mounting portions 122 of the roller seat 12 is formed with two notches 1220 allowing the rotating shafts 320 of the respective one of the rollers 32 to be respectively and rotatably received therein such that the respective one of the rollers 32 is rotatably mounted on the mounting portion 122.

To apply makeup using the makeup applicator of the present disclosure, the rollers 32 exposed in the openings 111 are operated to rotate in opposite directions by fingers of a user. For example, an upwardly moving force is exerted on both of the rollers 32 relative to the tube body 11, such that the left one of the rollers 32 in FIG. 3 rotates in a clockwise direction and the right one of the rollers 32 rotates in a counterclockwise direction. The pushing rod 31 is thus clamped by the pawls 322 of both of the rollers 32 and moved downwardly in the channel 121 into the passage 211 through the guiding portion 212 to contact the cosmetic stick 22. The cosmetic stick 22 is then moved downwardly by the pushing rod 31 to be exposed outwardly of the upright inner tube portion 213 of the cosmetic-receiving tube 21 for a user to apply makeup. To retract the cosmetic stick 22 after using, a downwardly moving force is exerted on the rollers 32 to make the pushing rod 31 move upwardly together with the cosmetic stick 22 adhered thereto and thus the cosmetic stick 22 is retracted into the upright inner tube portion 213.

When replacement of the refill unit 2 is required, for example, when the cosmetic stick 22 is consumed or a different color or kind of the cosmetic stick 22 is required, the rollers 32 are first operated to move the pushing rod 31 upwardly into the channel 121 of the roller seat 12 and then the tip portion 13 is loosened from the roller seat 12, i.e., the internal thread 133 of the tip portion 13 is disengaged from the external thread 124 of the roller seat 12, so as to allow removal of the refill unit 2 from the tip portion 13. After another refill unit having a structure identical to the replaced refill unit 2 is inserted into the tip portion 13, the tip portion 13 is threadedly mounted to the roller seat 12 so that the refill unit 2 is positioned in the tip portion 3.

To sum up, by virtue of the structure of the makeup applicator of the present disclosure, the cosmetic stick 22 is fittingly surrounded by the cosmetic-receiving tube 21 such that distortion or fracture of the cosmetic stick 22 can be prevented when applying makeup. Additionally, the cosmetic-receiving tube 21 and the cosmetic stick 22 are integrated as a set and thus can be replaced in a relatively convenient manner. Further, the control unit 3 provides a transmission mechanism for driving the cosmetic stick 22 to move in the passage 211 so as to be exposed outwardly of and retracted into the upright inner tube portion 213 when both of the rollers 32 are operated by upwardly and downwardly moving force, respectively.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A makeup applicator comprising:
a tube unit being hollow and extending along a central axis;
a refill unit detachably mounted in said tube unit, and including a cosmetic-receiving tube that defines a passage extending along the central axis therein and a cosmetic stick that is movable in said passage; and
a control unit including a pushing rod that is movably inserted into said passage and that is co-movably connected to said cosmetic stick, and at least one roller that is rotatably mounted to said tube unit and rotatable to drive said pushing rod to move along the central axis together with said cosmetic stick.

2. The makeup applicator as claimed in claim 1, wherein each of said cosmetic stick and said passage is circular in cross section, and said cosmetic stick has a maximum diameter smaller than that of said passage.

3. The makeup applicator as claimed in claim 1, wherein said control unit includes two said rollers disposed respectively and rotatably at diametrically opposite sides of said pushing rod, each of said rollers being rotatable about a horizontal axis transverse to the central axis, the horizontal axes of said rollers being parallel to each other.

4. The makeup applicator as claimed in claim 3, wherein each of said rollers includes a wheel body rotatable about the respective one of the horizontal axes, and a plurality of pawls extending radially and outwardly from a peripheral surface of said wheel body and angularly and equidistantly spaced apart from one another about the respective one of the horizontal axes, one of said pawls of one of said rollers facing and cooperating with a corresponding one of said pawls of the other one of said rollers to clamp said pushing rod therebetween so as to move said pushing rod in said passage when said rollers are rotated in opposite directions.

5. The makeup applicator as claimed in claim 4, wherein said wheel body of each of said rollers has a wheel peripheral surface formed with an annular groove, each of said pawls being disposed in said annular groove of a corresponding one of said wheel bodies of said rollers, a portion of said wheel peripheral surface of one of said rollers facing and cooperating with a portion of said wheel peripheral surface of the other one of said rollers to surround said pushing rod.

6. The makeup applicator as claimed in claim 1, wherein said tube unit includes a tube body, a roller seat connected to a lower end of said tube body to allow mounting of said at least one roller thereon and defining a channel through which said pushing rod extends and which is in spatial communication with said passage, and a tip portion extending downwardly from said tube body along the central axis and detachably connected to said roller seat.

7. The makeup applicator as claimed in claim 6, wherein said tube body is formed with at least one opening in spatial communication with said passage and the ambient surroundings, and corresponding in position to said at least one roller to allow a portion of said roller to be exposed therein.

8. The makeup applicator as claimed in claim 7, wherein said tip portion includes an upright outer sleeve surrounding the central axis, a connection wall connected to an upper end of said outer sleeve and detachably mounted to said roller seat, and a shoulder wall formed between said outer sleeve and said connecting wall, said cosmetic-receiving tube including an upright inner tube portion on which said outer sleeve is sleeved, and a flange portion which extends radially and outwardly from an upper end of said inner tube portion and which is disposed on and abuts against said shoulder wall of said tip portion.

9. The makeup applicator as claimed in claim 8, wherein said roller seat includes at least one roller mounting portion extending into said tube body and configured to mount said at least one roller rotatably thereon, and a tip-connecting portion extending downwardly from said tube body into said tip portion, and formed with an external thread, said connecting wall of said tip portion being formed with an internal thread that threadedly and detachably engages said external thread.

10. The makeup applicator as claimed in claim 9, wherein said tube body is formed with two said openings, said control unit including two said rollers disposed respectively and rotatably at diametrically opposite sides of said pushing rod and corresponding respectively in position to said openings, each of said rollers being rotatable about a horizontal axis transverse to the central axis, the horizontal axes of said rollers being parallel to each other, said roller seat including two said roller mounting portions extending into said tube body and configured to mount roller rotatably thereon.

11. The makeup applicator as claimed in claim 10, wherein each of said rollers includes a wheel body rotatable about a respective one of the horizontal axes, and a plurality of pawls extending radially and outwardly from a peripheral surface of said wheel body and angularly and equidistantly spaced apart from one another about the respective one of the horizontal axes, one of said pawls of one of said rollers facing and cooperating with a corresponding one of said pawls of the other one of said rollers to clamp said pushing rod therebetween so as to move said pushing rod in said passage when said rollers are rotated in opposite directions.

12. The makeup applicator as claimed in claim 11, wherein said wheel body of each of said rollers has a wheel peripheral surface formed with an annular groove, each of said pawls being disposed in said annular groove of a corresponding one of said wheel bodies of said rollers, a portion of said wheel peripheral surface of one of said rollers facing and cooperating with a portion of said wheel peripheral surface of the other one of said rollers to surround said pushing rod.

13. The makeup applicator as claimed in claim 9, wherein said at least one roller is rotatable about a horizontal axis transverse to the central axis, and has a wheel body and two rotating shafts respectively extending from two opposite ends of said wheel body away from each other along the horizontal axis, said at least one roller mounting portion being formed with two notches allowing said rotating shafts to be respectively and rotatably received therein such that said at least one roller is rotatably mounted on said at least one mounting portion of said roller seat.

14. The makeup applicator as claimed in claim 9, wherein said tube body is further formed with at least one first engaging portion extending in a direction parallel to the central axis, said roller seat being formed with at least one second engaging portion extending in a direction parallel to the central axis and engaging said first engaging portion so as to prevent said roller seat from rotating relative to said tube body.

15. The makeup applicator as claimed in claim 14, wherein said first engaging portion is one of an open-ended slot and a rib and said second engaging portion is the other one of the open-ended slot and the rib.
